(19) United States
(12) Patent Application Publication
(10) Pub. No.: US 2024/0364485 A1
(43) Pub. Date: Oct. 31, 2024

(54) TRANSMITTING A CHANNEL STATE INFORMATION REPORT

(71) Applicant: Lenovo (Singapore) Pte. Ltd., New Tech Park (SG)

(72) Inventors: Ahmed Hindy, Aurora, IL (US); Razvan-Andrei Stoica, Essen (DE); Vijay Nangia, Woodridge, IL (US)

(21) Appl. No.: 18/290,970

(22) PCT Filed: Jul. 21, 2022
(86) PCT No.: PCT/IB2022/056770

§ 371 Date: Jan. 22, 2024

Related U.S. Application Data
(60) Provisional application No. 63/224,293, filed on Jul. 21, 2021.

(51) Int. Cl. H04L 5/00; H04B 7/0456

(52) U.S. Cl. CPC H04L 5/0057; H04B 7/0478

(57) ABSTRACT

Apparatuses, methods, and systems are disclosed for transmitting a channel state information report. One method includes receiving a set of reference signals based on at least one resource setting configuring a UE for a CSI measurement. The method includes determining a set of CSI feedback parameters based on the set of reference signals and at least one report setting configuring the UE for CSI reporting. The method includes transmitting a CSI report to a network. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension.

### CROSS-REFERENCE TO RELATED APPLICATIONS

This application claims priority to U.S. patent application Ser. No. 63/224,293 entitled “APPARATUSES, METHODS, AND SYSTEMS FOR A NOVEL CODEBOOK FOR HIGH-SPEED USER SCENARIOS WITH DOPPLER REPORTING” and filed on Jul. 21, 2021 for Ahmed Hindy et al., which is incorporated herein by reference in its entirety.

### FIELD

The subject matter disclosed herein relates generally to wireless communications and more particularly relates to transmitting a channel state information report.

### BACKGROUND

In certain wireless communications networks, CSI feedback may be used. In such networks, the CSI feedback may be transmitted over a variety of times and/or frequencies.

### BRIEF SUMMARY

Methods for transmitting a channel state information report are disclosed. Apparatuses and systems also perform the functions of the methods. One embodiment of a method includes receiving, at a UE, a set of reference signals based on at least one resource setting configuring the UE for a CSI measurement. In some embodiments, the method includes determining a set of CSI feedback parameters based on the set of reference signals and at least one report setting configuring the UE for CSI reporting. In certain embodiments, the method includes transmitting a CSI report to a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension.

One apparatus for transmitting a channel state information report includes a receiver to receive a set of reference signals based on at least one resource setting configuring the apparatus for a CSI measurement. In various embodiments, the apparatus includes a processor to determine a set of CSI feedback parameters based on the set of reference signals and at least one report setting configuring the apparatus for CSI reporting. In some embodiments, the apparatus includes a transmitter to transmit a CSI report to a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension.

Another embodiment of a method for transmitting a channel state information report includes transmitting, from a network device, a set of reference signals based on at least one resource setting configuring the apparatus for a CSI measurement. A set of CSI feedback parameters is determined based on the set of reference signals and at least one report setting configuring the apparatus for CSI reporting. In some embodiments, the method includes receiving a CSI report at a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension.

Another apparatus for transmitting a channel state information report includes a transmitter to transmit a set of reference signals based on at least one resource setting configuring the apparatus for a CSI measurement. A set of CSI feedback parameters is determined based on the set of reference signals and at least one report setting configuring the apparatus for CSI reporting. In various embodiments, the apparatus includes a receiver to receive a CSI report at a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for transmitting a channel state information report;

FIG. 2 is a schematic block diagram illustrating one embodiment of an apparatus that may be used for transmitting a channel state information report;

FIG. 3 is a schematic block diagram illustrating one embodiment of an apparatus that may be used for transmitting a channel state information report;

FIG. 4 is a schematic block diagram illustrating one embodiment of code for an aperiodic trigger state that indicates a resource set and QCL information;

FIG. 5 is a schematic block diagram illustrating one embodiment of code that describes an RRC configuration for an NZP-CSI-RS resource;

FIG. 6 is a schematic block diagram illustrating one embodiment of code that describes an RRC configuration for an CSI-IM resource;

FIG. 7 is a flow chart diagram illustrating one embodiment of a method for transmitting a channel state information report; and

FIG. 8 is a flow chart diagram illustrating another embodiment of a method for transmitting a channel state information report.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all ofthe items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments oflike elements.

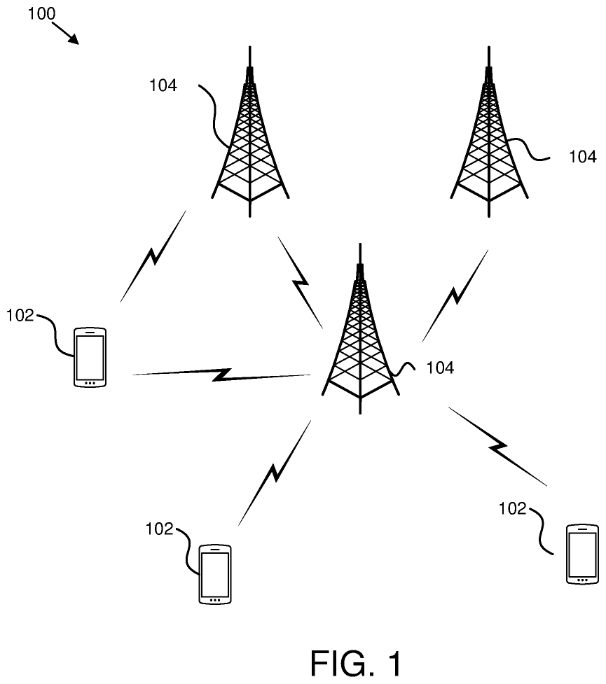

FIG. 1 depicts an embodiment of a wireless communication system 100 for transmitting a channel state information report. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a set of reference signals based on at least one resource setting configuring the UE for a CSI measurement. In some embodiments, the remote unit 102 may determine a set of CSI feedback parameters based on the set of reference signals and at least one report setting configuring the UE for CSI reporting. In certain embodiments, the remote unit 102 may transmit a CSI report to a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension. Accordingly, the remote unit 102 may be used for transmitting a channel state information report.

In certain embodiments, a network unit 104 may transmit a set of reference signals based on at least one resource setting configuring the apparatus for a CSI measurement. A set of CSI feedback parameters is determined based on the set of reference signals and at least one report setting configuring the apparatus for CSI reporting. In some embodiments, the network unit 104 may receive a CSI report at a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension. Accordingly, the network unit 104 may be used for transmitting a channel state information report.

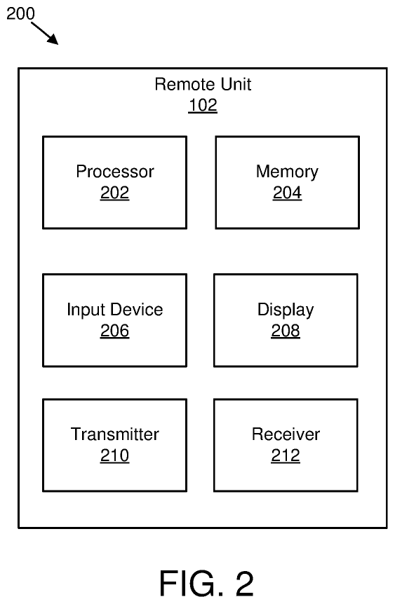

FIG. 2 depicts one embodiment of an apparatus 200 that may be used for transmitting a channel state information report. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 to receive a set of reference signals based on at least one resource setting configuring the apparatus for a CSI measurement. In various embodiments, the processor 202 to determine a set of CSI feedback parameters based on the set of reference signals and at least one report setting configuring the apparatus for CSI reporting. In some embodiments, the transmitter 210 to transmit a CSI report to a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

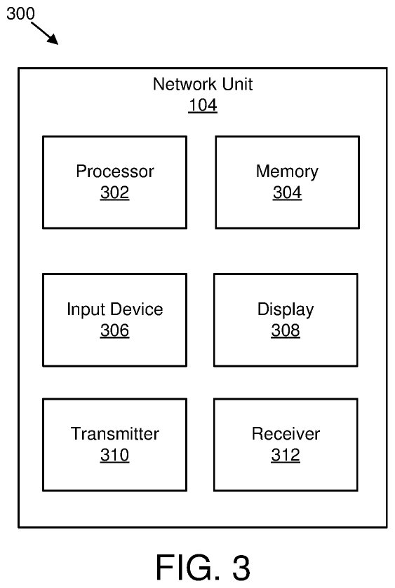

FIG. 3 depicts one embodiment of an apparatus 300 that may be used for transmitting a channel state information report. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 to transmit a set of reference signals based on at least one resource setting configuring the apparatus for a CSI measurement. A set of CSI feedback parameters is determined based on the set of reference signals and at least one report setting configuring the apparatus for CSI reporting. In various embodiments, the receiver 312 to receive a CSI report at a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension.

It should be noted that one or more embodiments described herein may be combined into a single embodiment.

In certain embodiments, such as for 3GPP new radio (“NR”), channel state information (“CSI”) feedback is reported by a user equipment (“UE”) to a network, where the CSI feedback may take multiple forms based on the CSI feedback report size, time, and frequency granularity. In some embodiments, such as in NR, a high-resolution CSI feedback report (e.g., Type-II) may be used, where the frequency granularity of the CSI feedback may be indirectly parametrized. In various embodiments, there may be scenarios in which a UE speed is relatively high (e.g., up to 500 km/h). To accommodate such scenarios while maintaining similar quality of service, a modified CSI framework, including measurement and reporting, may be used.

In some embodiments, CSI measurement and reporting that are suited for high-Doppler scenarios may be enabled, where a relative UE speed is relatively high. In various embodiments, CSI-RS configuration enhancements may help capture a time-varying channel under high Doppler shift and/or spread. In certain embodiments, a novel codebook design is used that reports a function of a Doppler shift for one or more channel paths.

In certain embodiments, there may be different NR codebook types. Details about different NR codebook types are provided herein.

In some embodiments, there is an NR Type-II codebook. In such embodiments, assume the gNB is equipped with a 2D antenna array with N₁, N₂ antenna ports per polarization placed horizontally and vertically and communication occurs over N₃ precoder matrix indicator (“PMI”) sub-bands. A PMI subband consists of a set of resource blocks, each resource block consisting of a set of subcarriers. In such case, 2N₁N₂ CSI-RS ports are utilized to enable DL channel estimation with high resolution for NR Type-II codebook. In order to reduce the UL feedback overhead, a DFT-based CSI compression of the spatial domain is applied to L dimensions per polarization, where L<N₁N₂. In the sequel the indices of the 2L dimensions are referred as the SD basis indices. The magnitude and phase values of the linear combination coefficients for each sub-band are fed back to the gNB as part of the CSI report. The 2N₁N₂×N₃ codebook per layer takes on the form: W=W₁W₂, where W₁ is a 2N₁N₂×2L block-diagonal matrix (L<N₁N₂) with two identical diagonal blocks, i.e.,

$$\\ {W}_{1} = [ \begin{matrix}B & 0 \\ 0 & B\end{matrix} ] ,$$

and B is an N₁N₂×L matrix with columns drawn from a 2D oversampled DFT matrix, as follows:

$$\\ {u}_{m} = [ 1 {e}^{{}_{} j \frac{2 π m}{{O}_{2} {N}_{2}}} … {e}^{{}_{} j \frac{2 π m ( {N}_{{}_{} 2} - 1 )}{{O}_{2} {N}_{2}}} ] ,$$

$$\\ {v}_{l , m} = {[ {u}_{m} {e}^{{}_{} j \frac{2 π l}{{O}_{1} {N}_{1}}} {u}_{m} … {e}^{{}_{} j \frac{2 π l ( {N}_{{}_{} 1} - 1 )}{{O}_{1} {N}_{1}}} ]}^{T} ,$$

$$\\ B = [ {v}_{{l}_{0} , {m}_{0}} {v}_{{l}_{1} , {m}_{1}} … {v}_{{l}_{L - 1} , {m}_{L - 1}} ] ,$$

$$\\ {l}_{i} = {O}_{1} {n}_{1}^{{}_{} ( i )} + {q}_{1} , 0 \leq {n}_{1}^{{}_{} ( i )} < {N}_{1} , 0 \leq {q}_{1} < {O}_{1} - 1 ,$$

$$\\ {m}_{i} = {O}_{2} {n}_{2}^{{}_{} ( i )} + {q}_{2} , 0 \leq {n}_{2}^{{}_{} ( i )} < {N}_{2} , 0 \leq {q}_{2} < {O}_{2} - 1 ,$$

where the superscript ^{T} denotes a matrix transposition operation. Note that O₁, O₂ oversampling factors are assumed for the 2D DFT matrix from which matrix B is drawn. Note that W₁ is common across all layers. W₂ is a 2Lx N₃ matrix, where the i^{th} column corresponds to the linear combination coefficients of the 2L beams in the i^{th} sub-band. Only the indices of the L selected columns of B are reported, along with the oversampling index taking on O₁ and O₂ values. Note that W₂ are independent for different layers.

In various embodiments, there may be an NR Type-II port selection codebook. In such embodiments, for Type-II port selection codebook, only K (where K≤2N₁N₂) beamformed CSI-RS ports are utilized in DL transmission, in order to reduce complexity. The KxN₃ codebook matrix per layer takes on the form: W=W₁^{PS}W₂.

Here, W₂ follow the same structure as the conventional NR Rel. 15 Type-II Codebook and are layer specific. W^{P}s is a K×2L block-diagonal matrix with two identical diagonal blocks, i.e.,

$$\\ {W}_{1}^{{}_{} PS} = [ \begin{matrix}E & 0 \\ 0 & E\end{matrix} ] ,$$

### and E is an

$$\frac{K}{2} \times L$$

matrix whose columns are standard unit vectors, as follows:

$$E = [ \begin{matrix}{e}_{mod ( {m}_{PS} {D}_{PS} , K / 2 )}^{( K / 2 )} & {e}_{mod ( {m}_{PS} {D}_{PS} 1 + , K / 2 )}^{( K / 2 )} & … & {e}_{mod ( {m}_{PS} {D}_{PS} + L - , K / 2 )}^{( K / 2 )}\end{matrix} ] ,$$

where eᵢ^{(K)} is a standard unit vector with a 1 at the ith location. Here d_{PS} is a radio resource control (“RRC”) parameter which takes on the values {1,2,3,4} under the condition d_{PS}≤min(K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers. For K=16, L=4 and d_{PS}=1, the 8 possible realizations of E corresponding to m_{PS}={0,1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , \\ [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 0 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] ,$$

To summarize, m_{PS} parametrizes the location of the first 1 in the first column of E, whereas d_{PS} represents the row shift corresponding to different values of m_{PS}.

In various embodiments, there may be an NR Type-I codebook. In such embodiments, NR Type-I codebook is the baseline codebook for NR, with a variety of configurations. The most common utility of Type-I codebook is a special case of NR Type-II codebook with L=1 for RI=1,2, wherein a phase coupling value is reported for each sub-band, i.e., W₂ is 2×N₃, with the first row equal to [1, 1, . . . , 1] and the second row equal to [e^{j2πØ}^{₀}, . . . , e^{j2πØ}^{_{N3-1}}]. Under specific configurations, ϕ₀=ϕ₁ . . . =ϕ, i.e., wideband reporting. For RI>2 different beams are used for each pair of layers. Obviously, NR Rel. 15 Type-I codebook can be depicted as a low-resolution version of NR Rel. 15 Type-II codebook with spatial beam selection per layer-pair and phase combining only.

In certain embodiments, there may be an NR Type-II codebook. In such embodiments, assume the gNB is equipped with a two-dimensional (2D) antenna array with N₁, N₂ antenna ports per polarization placed horizontally and vertically and communication occurs over N₃ PMI sub-bands. A PMI sub-band consists of a set of resource blocks, each resource block consisting of a set of subcarriers. In such case, 2N₁N₂N₃ CSI-RS ports are utilized to enable DL channel estimation with high resolution for NR Type-II codebook. In order to reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

W=W₁\tilde{W}₂W_{f}^{H},
where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π m ( {N}_{1} - 1 )}{{O}_{1} {N}_{1}}}\end{matrix} {u}_{m} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1.$$

Note that 01, 02 oversampling factors are assumed for the 2D DFT matrix from which matrix B is drawn. Note that W₁ is common across all layers. W_{f} is an N₃×M matrix (M<N₃) with columns selected from a critically sampled size-N₃ DFT matrix, as follows:

$${W}_{f} = [ \begin{matrix}{f}_{{k}_{0}} & {f}_{{k}_{1}} & … & {f}_{{k}_{{M}^{′} - 1}}\end{matrix} ] , 0 \leq {k}_{i} < {N}_{3} - 1 ,$$

$${f}_{k} = [ \begin{matrix}1 & {e}^{- j \frac{2 π k}{{N}_{3}}} & … & {{e}^{- j \frac{2 π k ( {N}_{3} - 1 )}{{N}_{3}}} ]}^{T} .\end{matrix}$$

Only the indices of the L selected columns of B are reported, along with the oversampling index taking on O₁ and O₂ values. Similarly, for W_{f}, only the indices of the M selected columns out of the predefined size-N₃ DFT matrix are reported. In the sequel the indices of the M dimensions are referred as the selected frequency domain (“FD”) basis indices. Hence, L, M represent the equivalent spatial and frequency dimensions after compression, respectively. Finally, the 2LxM matrix \tilde{W}₂ represents the linear combination coefficients (“LCCs”) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of ┌2βLM┐−1 coefficients (along with the indices of selected L, M DFT vectors) are reported per layer, leading to significant reduction in CSI report size, compared with reporting 2N₁N₂×N₃−1 coefficients' information.

In some embodiments, there may be an NR Type-II port selection codebook. For Type-II port selection codebook, only K (where K≤2N₁N₂) beamformed CSI-RS ports are utilized in DL transmission, in order to reduce complexity. The KxN₃ codebook matrix per layer takes on the form: W=W₁^{PS} \tilde{W}₂W_{f}^{H}. Here, W₂ and W₃ follow the same structure as the conventional NR Rel. 16 Type-II Codebook, where both are layer specific. The matrix W₁^{PS} is a Kx2L block-diagonal matrix with the same structure as that in the NR Type-II port selection codebook.

In various embodiments, there may be codebook reporting. The codebook report is partitioned into two parts based on the priority of information reported. Each part is encoded separately (Part 1 has a possibly higher code rate).

In certain embodiments, there may be a content of a CSI report as follows. Part 1: rank indicator (“RI”)+CQI+Total number of coefficients. Part 2: SD basis indicator+FD basis indicator/layer+Bitmap/layer+Coefficient Amplitude info/layer+Coefficient Phase info/layer +Strongest coefficient indicator/layer. Furthermore, Part 2 CSI can be decomposed into sub-parts each with different priority (higher priority information listed first). Such partitioning is required to allow dynamic reporting size for codebook based on available resources in the uplink phase. Also Type-II codebook is based on aperiodic CSI reporting, and only reported in physical uplink shared channel (“PUSCH”) via downlink control information (“DCI”) triggering (one exception). Type-I codebook can be based on periodic CSI reporting (physical uplink control channel (“PUCCH”)) or semi-persistent CSI reporting (PUSCH or PUCCH) or aperiodic reporting (PUSCH).

In some embodiments, there may be priority reporting for Part 2 CSI. It should be noted that multiple CSI reports may be transmitted as shown in Table 1.

TABLE 1
CSI Reports priority ordering
Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report
N_{Rep}, if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

It should be noted that the priority of the N_{Rep} CSI reports are based on the following. A CSI report corresponding to one CSI reporting configuration for one cell may have higher priority compared with another CSI report corresponding to one other CSI reporting configuration for the same cell. CSI reports intended to one cell may have higher priority compared with other CSI reports intended to another cell. CSI reports may have higher priority based on the CSI report content (e.g., CSI reports carrying L1-RSRP information have higher priority). CSI reports may have higher priority based on their type (e.g., whether the CSI report is aperiodic, semi-persistent or periodic, and whether the report is sent via PUSCH or PUCCH, may impact the priority of the CSI report).

In light of that, CSI reports may be prioritized as follows, where CSI reports with lower IDs have higher priority: Pri_{iCSI}, (y, k, c, s)=2·N_{cells}·Mₛ·y+N_{cells}·Mₛ·k+Mₛ·c+s, s: CSI reporting configuration index, and Ms: Maximum number of CSI reporting configurations, c: Cell index, and Ncells: Number of serving cells, k: 0 for CSI reports carrying layer 1 (“L1”) reference signal received power (“RSRP”) (“L1-RSRP”) or L1 signal-to-interference and noise ratio (“SINR”) (“L1-SINR”), 1 otherwise, y: 0 for aperiodic reports, 1 for semi-persistent reports on PUSCH, 2 for semi-persistent reports on PUCCH, 3 for periodic reports.

In certain embodiments, there may be a triggering of aperiodic CSI reporting on PUSCH. In such embodiments, a UE needs to report needed CSI information for a network using a CSI framework. The triggering mechanism between a report setting and a resource setting may be summarized as in Table 2.

TABLE 2
Triggering Mechanism Between a Report Setting and a Resource Setting

| | | Periodic CSI | | AP CSI |
|---|---|---|---|---|
| | | reporting | SP CSI reporting | Reporting |
| Time Domain | Periodic CSI- | RRC | MAC control | DCI |
| Behavior of | RS | configured | element (“CE”) | |
| Resource Setting | | | (PUCCH) | |
| | | | DCI (PUSCH) | |
| | SP CSI-RS | Not Supported | MAC CE (PUCCH) | DCI |
| | | | DCI (PUSCH) | |
| | AP CSI-RS | Not Supported | Not Supported | DCI |

In various embodiments, all associated resource settings for a CSI report setting need to have the same time domain behavior, such as: 1) periodic CSI-RS and/or IM resource and CSI reports are always assumed to be present and active once configured by RRC; 2) aperiodic and semi-persistent CSI-RS and/or IM resources and CSI reports needs to be explicitly triggered or activated; 3) aperiodic CSI-RS and/or IM resources and aperiodic CSI reports, the triggering is done jointly by transmitting a DCI Format 0-1; and/or 4) semi-persistent CSI-RS and/or IM resources and semi-persistent CSI reports are independently activated.

In certain embodiments, for aperiodic CSI-RS and/or IM resources and aperiodic CSI reports, the triggering is done jointly by transmitting a DCI Format 0-1. The DCI Format 0_1 contains a CSI request field (e.g., 0 to 6 bits). A non-zero request field points to a so-called aperiodic trigger state configured by RRC. An aperiodic trigger state in turn is defined as a list of up to 16 aperiodic CSI report settings, identified by a CSI report setting ID for which the UE calculates simultaneously CSI and transmits it on the scheduled PUSCH transmission.

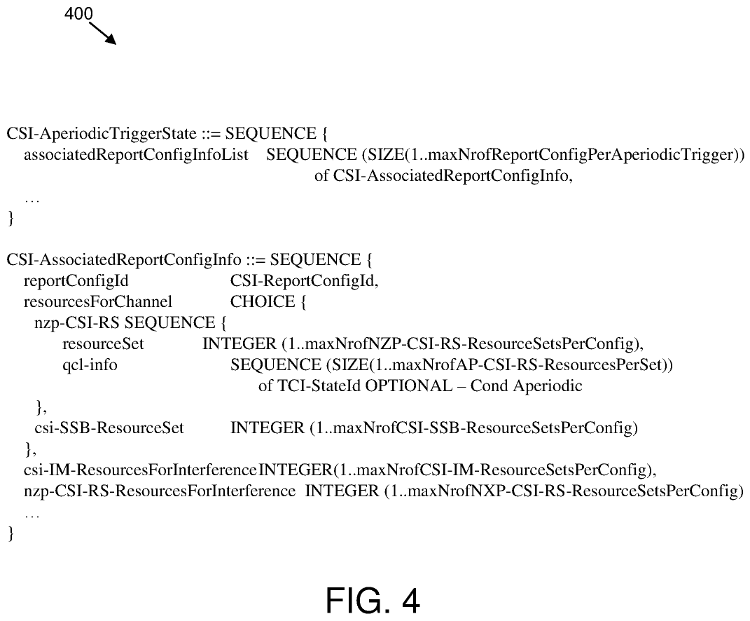

In some embodiments, if the CSI report setting is linked with an aperiodic resource setting (e.g., can comprise multiple resource sets), the aperiodic non-zero power (“NZP”) CSI-RS resource set for channel measurement, the aperiodic CSI interference management (“IM”) (“CSI-IM”) resource set (e.g., if used) and the aperiodic NZP CSI-RS resource set for IM (e.g., if used) to use for a given CSI report setting are also included in the aperiodic trigger state definition (e.g., see FIG. 4). For aperiodic NZP CSI-RS, the QCL source to use is also configured in the aperiodic trigger state. The UE assumes that the resources used for the computation of the channel and interference can be processed with the same spatial filter e.g., quasi-co-located with respect to “QCL-TypeD.”

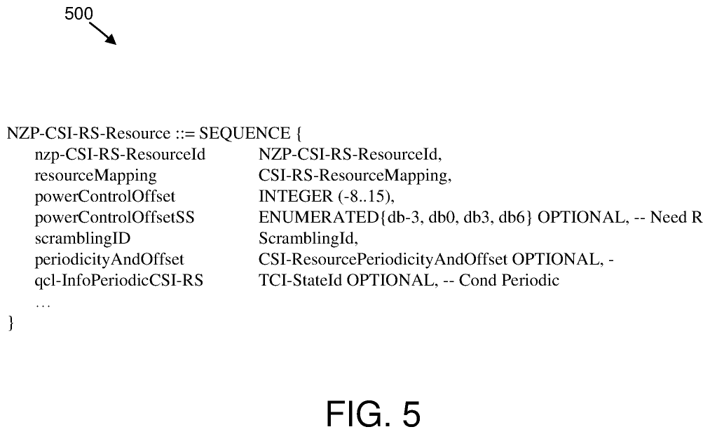

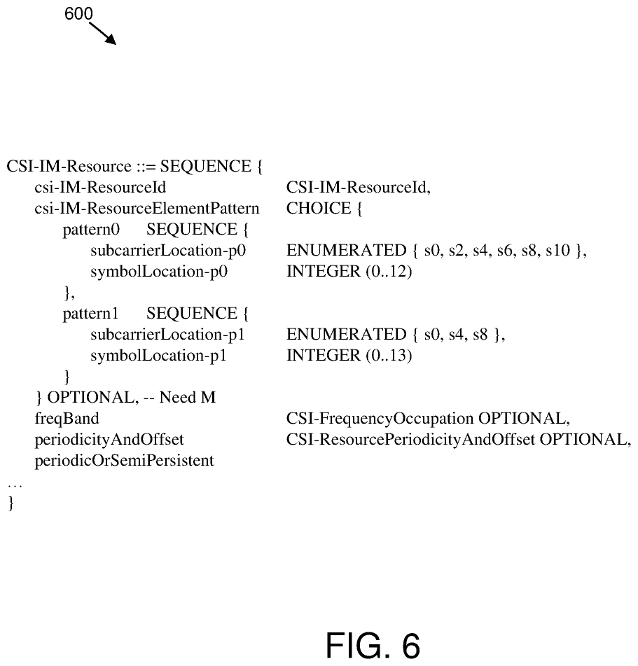

FIG. 4 is a schematic block diagram illustrating one embodiment of code 400 for an aperiodic trigger state that indicates a resource set and QCL information. FIG. 5 is a schematic block diagram illustrating one embodiment of code 500 that describes an RRC configuration for an NZP-CSI-RS resource. FIG. 6 is a schematic block diagram illustrating one embodiment of code 600 that describes an RRC configuration for an CSI-IM resource.

In Table 3 there is a summary of a type of uplink channels used for CSI reporting as a function of the CSI codebook type.

TABLE 3
Uplink Channels Used for CSI Reporting
as a Function of the CSI Codebook Type

| | Periodic CSI | SP CSI | AP CSI |
|---|---|---|---|
| | reporting | reporting | reporting |
| Type I WB | PUCCH Format 2, 3, 4 | PUCCH Format 2 | PUSCH |
| | | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |
| only | | | |

In certain embodiments, such as for aperiodic CSI reporting, PUSCH-based reports are divided into two CSI parts: CSI PartI and CSI Part 2. The reason for this is that the size of CSI payload varies significantly, and, therefore, a worst-case uplink control information (“UCI”) payload size design would result in large overhead. CSI Part 1 has a fixed payload size (and can be decoded by the gNB without prior information) and contains the following: rank indicator (“RI”) (if reported), CSI-RS resource index (“CRI”) (if reported), channel quality indicator (“CQI”) for the first codeword, and a number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 will be ordered.

In some embodiments, CSI reports are prioritized according to: 1) time-domain behavior and physical channel, where more dynamic reports are given precedence over less dynamic reports and PUSCH has precedence over PUCCH; 2) CSI content, where beam reports (e.g., L1-RSRP reporting) has priority over regular CSI reports; 3) the serving cell to which the CSI corresponds (e.g., in case of CA operation)—CSI corresponding to the PCell has priority over CSI corresponding to Scells; and/or 4) the reportConfigID.

In various embodiments, assume a channel between a UE and a gNB with P channel paths (index p=0, . . . , P−1) that occupies NSB frequency bands (index n=0, . . . , N_{SB}−1), wherein the gNB is equipped with K antennas (index k=0, . . . , K−1). The channel at a time index δ can then be represented as follows:

$${h}_{k , n} ( δ ) = {Σ}_{p = 0}^{P - 1} {g}_{k , p} {e}^{j 2 π n Δ f {τ}_{p} + j 2 π k \frac{{F}_{c} d}{c} sin {θ}_{p} + j 2 π δ \frac{{F}_{c} v}{c} c o s {∅}_{p}} ,$$

wherein g_{k,p} is a complex gain of path pat antenna k, Δf is a PMI sub-band spacing, τₚ is a delay of path p, F_{c} is a carrier frequency, c is the speed of light, d is an antenna spacing at gNB, θₚ is an angular spatial displacement at the gNB antenna array corresponding to path p, δ is a time index, ν is a relative speed between the gNB and the UE, and Φₚ is the angle between the moving direction and the signal incidence direction of path p. The channel is parametrized by three dimensions: spatial, frequency, and time dimensions. To construct a precoder codebook with reasonable CSI feedback overhead, the CSI corresponding to the three dimensions may need to be compressed. In a Type-II codebook, both spatial and frequency domains are compressed via DFT transformation of the spatial and frequency domains with columns of two-dimensional and one-dimensional DFT matrices, respectively. However, the temporal variations of the channel are often ignored in codebook design due to their negligible impact at low UE speed, e.g., small ν. This approximation may not be efficient for the following cases: 1) high UE speed (e.g., large ν); 2) haphazard motion (e.g., large variation in Φₚ); and/or 3) variation in other parameters (e.g., gₚ, τₚ, θₚ due to UE motion).

Several embodiments are described herein that extend the codebook design to include time-domain information with appropriate CSI feedback overhead. According to a possible embodiment, one or more elements or features from one or more of the described embodiments may be combined (e.g., for CSI measurement, feedback generation, and/or reporting which may reduce the overall CSI feedback overhead).

In a first set of embodiments, there may be CSI reporting for high-speed users. Under the CSI measurement and reporting framework for high-speed users, it may be beneficial that the UE feeds back the CSI temporal correlation to enable more concise CSI measurement and reporting at moderate and/or high UE speeds. Several embodiments that describe the CSI type for such codebook design are provided herein. According to a possible embodiment, one or more elements or features from one or more of the described embodiments may be combined (e.g., codebook type and codebook content under one or more of the primary and secondary codebook modes). In some examples, a codebook mode may include a codebook type and CSI feedback content.

In a first embodiment of the first set of embodiments, the codebook type for high-speed users is classified as a Type-I codebook (e.g., codebook sub-type set to ‘typeI-r18’).

In a second embodiment of the first set of embodiments, the codebook type for high-speed users is classified as a Type-II codebook (e.g., codebook sub-type set to ‘typell-r18’).

In a third embodiment of the first set of embodiments, the codebook type for high-speed users is classified as a Type-II port-selection codebook (e.g., codebook sub-type set to ‘typell-PS-r18’).

In a fourth embodiment of the first set of embodiments, the codebook type for high-speed users is classified as a new codebook class (e.g., codebook type set to Type-III codebook, and codebook sub-type set to ‘typeIII-r18’).

In a second set of embodiments (e.g., approach 0) of a high-speed codebook design, a codebook reported as part of the CSI corresponds to N₃ frequency units across No time units. The codebook takes on the form: Wₗ=W₁\tilde{W}_{2,l}W_{z,l}^{H}. The matrices W₁ and \tilde{W}_{2,1} here are assumed to have similar structure to that of a Type-II codebook at least with respect to dimensions. The matrix W_{z,l}^{H} is an M×N₃N_{δ} with M<N₃N_{δ} formed based on the 2D N₃N_{δ}×N₃N_{δ}-sized DFT matrix [symbol] obtained as follows:

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} , 0 \leq k \leq {N}_{3} - 1 ,$$

$${z}_{δ , k} = {[ \begin{matrix}{f}_{k}^{T} & {e}^{j \frac{2 π δ}{{N}_{δ}}} {f}_{k}^{T} & … & {e}^{j \frac{2 πδ}{{N}_{δ}}} {f}_{k}^{T} & … & {e}^{j \frac{2 πδ ( {N}_{δ} - 1 )}{{N}_{δ}}} {f}_{k}^{T}\end{matrix} ]}^{T} , 0 \leq δ \leq {N}_{δ} - 1 ,$$

$$= [ \begin{matrix}{z}_{0 , 0} & {z}_{0 , 1} & … & {z}_{δ , k} & {z}_{δ , k + 1} & {z}_{δ , k + 2} & … & {z}_{{N}_{δ} - 1 , {N}_{3} - 1}\end{matrix} ] , \\ 0 , \leq k \leq {N}_{3} - 1 , and 0 \leq δ \leq {N}_{δ} - 1.$$

The reduced matrix W_{z,l}^{H} obtained from the 2D-DFT matrix [symbol] critically sampling Mcolumns. Only the indices of the M selected columns out of the predefined 2D size-N₃N_{δ} DFT matrix are reported. Given the 2D DFT-based linear transform these may be referred to as joint frequency-time domain (“JFTD”) basis indices. They represent the joint encoding of the delay-Doppler information associated with the observation of CSI measurements across N₃ PMI subbands over N_{δ} time samples for layer 1. Thus, the magnitude and phase of the LCC entries of \tilde{W}_{2,1} contain additionally information about the Doppler effects of the propagation channel across the dominant paths, which are to be jointly reported. Under this setup, the layer/codebook may take on the form:

$${W}_{{q}_{1} , {q}_{2} , {n}_{1} , {n}_{2} , {n}_{3} , {p}_{l}^{( 1 )} , {p}_{l}^{( 2 )} , {i}_{2 , 5 , l} t , δ}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {p}_{l , i , f}^{( 2 )} {φ}_{l , i , f} {ψ}_{δ , l , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {p}_{l , i + L , f}^{( 2 )} {φ}_{l , i , L + f} {ψ}_{δ , l , f}\end{matrix} ] , \\ l = 1 , 2 , … , v , {γ}_{t , l , δ} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {p}_{l , i , f}^{( 2 )} {φ}_{l , i , f} {ψ}_{δ , l , f} \vert}^{2} .$$

Examples of the mappings from i₁ to q₁, q₂, n₁, n₂, n_{3,1}, n_{3,2}, n_{3,3}, n_{3,4}, and from i₂ to i_{2,5,1}, i_{2,5,2}, i_{2,5,3}, i_{2,5,4}, p₁⁽¹⁾, p₂⁽¹⁾, p₃⁽¹⁾ and p₄⁽¹⁾, p₁⁽²⁾, p₂⁽²⁾, p₃⁽²⁾ and p₄⁽²⁾ and quantity ϕ_{l,i,f} may be predetermined and/or may include the ranges of the constituent indices of i₁ and i₂, and δ that represent a time-dependent index. Here, ψ_{δ,i,f} represents the selected entry of the matrix W_{z,l}corresponding to the f^{th} selected transformed frequency-domain index, and the δ^{th} time index.

In a first embodiment of the second set of embodiments, the value N_{δ} representing the maximum number of time samples on which the reporting may be signaled, provided, and/or configured by the gNB with a transmission to the UE (e.g., higher layer configured or dynamically indicated based on L1 signaling).

In a second embodiment of the second set of embodiments, the UE receives up to N_{δ} CSI-RS transmissions across up to N_{δ} slots. In a first example, the UE feeds back a request to the network to transmit the up to N_{δ} CSI-RS transmissions, wherein the gNB may or may not fulfill the request of the UE. In a second example, a UE configured with receiving up to N_{δ} CSI-RS transmissions across up to N_{δ} slots is characterized by a UE capability.

In a third embodiment of the second set of embodiments, the value N_{δ} may be determined by the UE based on the number of CSI-RS symbols in a burst indicated in at least one of the CSI reporting setting and the CSI resource setting. In one example, N_{δ} represents the number of consecutive CSI-RS transmissions under a specific CSI-RS configuration.

In a fourth embodiment of the second set of embodiments, upon the UE receiver capabilities, the UE may use advanced receiving techniques to track the channel. For instance, log-likelihood ratios of decoded symbols, received channels (e.g., physical downlink shared channel (“PDSCH”)), or other RS (e.g., tracking reference signal (“TRS”), DM-RS) may be used to successively improve initial CSI estimation and generate new CSI samples. The obtained CSI samples may be used by the UE to update previous reports in which case the UE may report to the gNB the autonomously selected N_{δ} in part I of the CSI report.

In a fifth embodiment of the second set of embodiments, the M indices corresponding to the selected columns of the 2D DFT matrix of dimension N₃N_{δ}×N₃N_{δ} are reported by the UE in terms of a combinatorial function. In one example, the bitwidth for reporting the selected columns is in the order of

$$⌈ {log}_{2} ( \begin{matrix}{N}_{3} {N}_{δ} \\ M\end{matrix} ) ⌉ .$$

In one example, the positions of the M selected columns of the 2D DFT matrix corresponding to the M indices in set {kᵢ}ᵢ₌₀^{M-1},

$$r = {\sum }_{i = 0}^{M - 1} 〈 \begin{matrix}L - {k}_{i} \\ M - i\end{matrix} 〉 = {\sum }_{i = 0}^{M - 1} C ( L - {k}_{i} , M - i ) and 〈 \begin{matrix}x \\ y\end{matrix} 〉 = C ( x , y ) = \{ \begin{matrix}( \begin{matrix}x \\ y\end{matrix} ) & x \geq y \\ 0 & x < y\end{matrix}$$

is the extended binomial coefficient, resulting in unique label

$$r ∈ \{ 0 , … , ( \begin{matrix}L \\ M\end{matrix} ) - 1 \} .$$

In a sixth embodiment of the second set of embodiments, the matrix W of size M×N₃N_{δ} with M<N₃N_{δ} may be formed based on the generalized O₃O₄-oversampled O₃N₃O₄N_{δ}×N₃N_{δ}-sized 2D DFT matrix [symbol] obtained as follows:

$${f}_{k} = {[ \begin{matrix}1 & {e}^{- j \frac{2 π k}{{O}_{3} {N}_{3}}} & … & {e}^{- j \frac{2 π k ( {N}_{3} - 1 )}{{O}_{3} {N}_{3}}}\end{matrix} ]}^{T} ,$$

$$0 \leq k \leq {N}_{3} - 1 ,$$

$${z}_{δ , k} = {[ \begin{matrix}{f}_{k}^{T} & {e}^{{j \frac{2 π δ}{{O}_{4} {N}_{δ}}}^{}} {f}_{k}^{T} & … & {e}^{j \frac{2 πδ}{{O}_{4} {N}_{δ}}} {f}_{k}^{T} & … & {e}^{j \frac{2 π δ ( {N}_{δ} - 1 )}{{O}_{4} {N}_{δ}}} & {f}_{k}^{T}\end{matrix} ]}^{T} ,$$

$$0 \leq δ \leq {N}_{δ} - 1 ,$$

$${{W}_{z , l}}^{⌣} = [ \begin{matrix}{z}_{0 , 0} & {z}_{0 , 1} & … & {z}_{δ , k} & {z}_{δ , k + 1} & {z}_{δ , k + 2} & … & {z}_{{N}_{δ} - 1 , {N}_{3} - 1}\end{matrix} ] ,$$

$$0 \leq k \leq {N}_{3} - 1 , 0 \leq δ \leq {N}_{δ} - 1 .$$

The oversampling factors O₃ and O₄ apply to the frequency domain and time domain respectively. The reduced matrix W_{z,l}^{H} is obtained from the 2D-DFT matrix W_{Z,l} from above by critically sampling Mcolumns as:

W_{z,l}^{H}=[z_{δ}_{₀}ₖ_{₀}z_{δ}_{₁}_{,k}_{₁}. . . z_{δ}_{_{M-1}}_{,k}_{_{M-1}}]^{H},0≤k<N₃,0≤δᵢ<N_{δ}, and 0≤i≤M−1.

Only the indices of the M selected columns out of the oversampled 2D O₃N₃O₄N_{δ}×N₃N_{δ}-sized DFT matrix are reported, wherein O₃≥1, O₄≥1, and the value of each of O₃, O₄ can be higher-layer configured by the network, set by a rule in the specification, or reported by the UE within the CSI report. Given the 2D DFT-based linear transform these may be referred to as JFTD basis indices. They represent the joint encoding of the delay-Doppler information associated with the observation of O₃O₄-oversampled CSI measurements across N₃ PMI subbands over N_{δ} time samples for layer l. In one example, each of O₃, O₄, may take on values {1,2,4}.

In some examples, the M columns of the 2D-DFT may be provided and/or configured with a transmission to a device, selected by the device, or predetermined by a rule (e.g., in a specification). In another example, the M columns may correspond to non-uniform sampling of the columns of the 2D-DFT. In another example, the value of M may be based on at least one of the maximum Doppler spread, Doppler shift, excess delay spread, rms delay spread, or may be provided and/or configured with a transmission to a device. In some examples, the 2D-DFT may be decomposed in two matrices representing the frequency domain (“FD”) basis and time-domain basis, respectively. In some examples, the matrix W_{z,i} may be common for all ν layers, e.g., matrix W_{z,1}=W_{z,2}= . . . =W_{z,ν}.

In a third set of embodiments (e.g., approach 1) of the high-speed codebook design, the codebook takes on the form: Wₗ=W₁\tilde{W}_{2,l}W_{δ,l}W_{f,l}^{H}. The matrices W₁, \tilde{W}_{2,l} and W_{f,l}, are assumed to have similar structure to that of a Type-II codebook, at least with respect to dimensions. W_{δ,l} is an M×M diagonal matrix, whose diagonal entries take on the form:

$${ψ}_{δ , l , f} = {e}^{j \frac{2 π δ {d}_{l , f}}{{N}_{d}}} ,$$

where d_{l,f}=0,1, . . . , N_{d}−1, and δ represents a time index corresponding to the slot, or a group of one or more slots. Under this setup, the layer/codebook may take on the form:

$${W}_{{q}_{1} , {q}_{2} , {n}_{1} , {n}_{2} , {n}_{3} , {p}_{l}^{( 1 )} , {p}_{l}^{( 2 )} , {i}_{2 , 5 , l} , t , δ}^{l} = \frac{1}{\sqrt{{N}_{1} {N}_{2} {γ}_{t , l}}} [ \text{} \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} {ψ}_{δ , l , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f} {ψ}_{δ , l , f}\end{matrix} ] , l = 1 , 2 , … , v ,$$

$$and$$

$${γ}_{t , l , δ} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {φ}_{l , i , f} {ψ}_{δ , l , f} \vert}^{2} .$$

Examples of the mappings from i₁ to q₁, q₂, n₁, n₂, n_{3,1}, n_{3,2}, n_{3,3}, n_{3,4}, and from i₂ to i_{2,5,1}, i_{2,5,2}, i_{2,5,3}, i_{2,5,4}, p₁⁽¹⁾, p₂⁽¹⁾, p₃⁽¹⁾ and p₄⁽¹⁾, p₁⁽¹⁾, p₂⁽²⁾, p₃⁽²⁾ and p₄ ⁽²⁾ and quantity ϕ_{l,i,f} may be predetermined, including the ranges of the constituent indices of i₁ and i₂, and δ represents a time-dependent index.

In a first embodiment of the third set of embodiments, a phase value or an indication of the phase value corresponding to the Doppler shift exponent

$${e}^{j 2 π δ \frac{{F}_{c} ν}{c} cos {∅}_{l , f}}$$

is reported, e.g., such that the reported d_{l,f}, is equivalent to the term

$${d}_{l , f} = 2 π \frac{{F}_{c} v}{c} cos {∅}_{l , f} .$$

In a second embodiment of the third set of embodiments, the value N_{d} is higher-layer configured. In one example, N_{d} is a power-of-two value, e.g., is in the form 2ⁿ for a non-negative integer value n, e.g., n=4, and N_{d}=16.

In a third embodiment of the third set of embodiments, the value d_{l,f} is reported by the UE as part of the CSI feedback report, wherein the bitwidth of d_{l,f} is [log₂ N_{d}].

In a fourth embodiment of the third set of embodiments, the value d_{l,f} is common for all ν layers, i.e., d_{1,f}=d_{2,f}= . . . =d_{ν,f}.

In a fifth embodiment of the third set of embodiments, the value d_{i,f} is common for all transformed frequency domain indices, e.g., d_{1,1}=d_{1,2}= . . . =d_{l,M}.

In a sixth embodiment of the third set of embodiments, the codebook follows a Type-I codebook approach, in which a beam is selected with a co-phasing value reported for another beam.

In a fourth set of embodiments (e.g., approach 2) of the high-speed codebook design, the codebook takes on the form: Wₗ=W₁\tilde{W}_{2,l}W_{δ,l} H. The matrices W₁, \tilde{W}_{2,1} and W_{f,l}are assumed to have similar structure to that of a Type-II codebook, at least with respect to dimensions. W_{δ,l} is an M×M diagonal matrix, whose diagonal entries take on the form:

$${ψ}_{δ , l , f} = {e}^{j \frac{2 πδ {F}_{c}^{υ}}{c} cos {∅}_{l , f}} , where {∅}_{l , f} {=}^{Δ} 2 πd / {N}_{d} , or {∅}_{l , f} {=}^{Δ} 2 π \frac{d + \frac{1}{2}}{{N}_{d}} , d = 0 , 1 , … , {N}_{d} - 1 ,$$

and δ represents a time index corresponding to the pre-coded slot or a group of one or more slots.

Under this approach, the UE reports an estimate of Oj, given the assumption that both the network and UE have a similar coarse estimate of the scalar relative speed ν between the UE and network, e.g., via SRS measurements in the UL and TRS measurements in the DL, respectively, via RRC configuration, or via explicit signaling of the Doppler value. Both the network and the UE may be expected to have an estimate of the carrier frequency, F_{c}, as well as the speed-of-light constant value, c.

Under this setup, the layer l codebook may take on the form:

$${W}_{{q}_{1} , {q}_{2} , {n}_{1} , {n}_{2} , {n}_{3} , {p}_{l}^{( 1 )} , {p}_{l}^{( 2 )} , {i}_{2 , 5 , l} , t , δ}^{l} = \frac{1}{\sqrt{{N}_{1} {N}_{2} {γ}_{t , l}}} [ \text{} \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} {ψ}_{δ , l , f} \\ {\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , + L , f}^{( 2 )} {φ}_{l , i + L , f} {ψ}_{δ , l , f}\end{matrix} ] , l = 1 , 2 , … , v ,$$

$$and$$

$${γ}_{t , l , δ} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {φ}_{l , i , f} {ψ}_{δ , l , f} \vert}^{2} .$$

Examples of the mappings from i₁ to q₁, q₂, n₁, n₂, n_{3,1}, n_{3,2}, n_{3,3}, n_{3,4}, and from i₂ to i_{2,5,1}, i_{2,5,2}, i_{2,5,3}, i_{2,5,4}, p₁⁽¹⁾, p₂⁽¹⁾, p₃⁽¹⁾ and p₄^{(1), p}₁⁽²⁾, p₂⁽²⁾, p₃⁽²⁾, and p₄⁽²⁾ and quantity ϕ_{l,i,f} may be predetermined, including the ranges of the constituent indices of i₁ and i₂, and δ represents a time-dependent index.

In a first embodiment of the fourth set of embodiments, a phase value or an indication of the phase value corresponding to the Doppler shift exponent

$${e}^{j 2 π δ \frac{{F}_{c} ν}{c} cos {∅}_{l , f}}$$

in is reported, e.g., such that the reported d_{l,f} is equivalent to the term d_{l,f}=Øl,j. In a first example, the parameter d_{l,f} represents a quantization of the term Ø_{l,f} with values within the range [−π,π]. In a second example, the parameter d_{l,f} represents a quantization of the term Ø_{l,f}+π, with values within the range [0,2π]. In a third example, the parameter d_{l,f} represents a quantization of the term (Ø_{l,f}+π)/2π, with values within the range [0,1].

In a second embodiment of the fourth set of embodiments, a phase value or an indication of the phase value corresponding to the Doppler shift exponent

$${e}^{j 2 π δ \frac{{F}_{c} ν}{c} cos {∅}_{l , f}}$$

is reported, e.g., such that the reported d_{l,f} is equivalent to the term d_{l,f}=cos Ø_{l,f}. In a first example, the parameter d_{l,f} represents a quantization of the term cos Ø^{l,f} with values within the range [−1,1]. In a second example, the parameter d_{l,f} represents a quantization of the term (1+cos Ø_{l,f})/2, with values within the range [0,1]. In a third example, the parameter d_{l,f} represents a quantization of the term

$$( 1 + cos {∅}_{l , f} ) \frac{{N}_{d}}{2} - 1 ,$$

with values {0,1, N_{d}−1}.

In a third embodiment of the fourth set of embodiments, the value N_{d} is higher-layer configured. In one example, N_{d} is a power-of-two value, e.g., is in the form 2ⁿ for a non-negative integer value n, e.g., n=4 and N_{d}=16.

In a fourth embodiment of the fourth set of embodiments, the value d_{l,f} is reported by the UE as part of the CSI feedback report, wherein the bitwidth of d_{l,f} is [log₂ N_{d}].

In a fifth embodiment of the fourth set of embodiments, the value d_{l,f} is common for all ν layers, e.g., d_{1,f}=d_{2,f}= . . . =d_{ν,f}.

In a sixth embodiment of the fourth set of embodiments, the value dif is common for all transformed frequency domain indices, i.e., d_{l,1}=d_{l,2}= . . . =d_{l,M}.

In a seventh embodiment of the fourth set of embodiments, the codebook follows a Type-I codebook approach, in which a beam is selected with a co-phasing value reported for another beam.

In a fifth set of embodiments (e.g., approach 3) of the high-speed codebook design, the codebook takes on the form: Wₗ=W₁\tilde{W}_{2,l}W_{δ,l}W_{f,l}^{H}. The matrices W₁, \tilde{W}_{2,l} and W_{f,l} are assumed to have similar structure to that of a Type-II codebook, at least with respect to dimensions. W_{δ,l} is an M×M diagonal matrix, whose diagonal entries take on the form:

$${ψ}_{δ , l , f} = {e}^{j \frac{2 π δ {aF}_{c} {v}_{max}}{c} cos {ϕ}_{l , f}} .$$

Under this approach, the UE reports an estimate of the product term αcos Ø_{l,f}, wherein α≤1 represents a speed attenuation factor with respect to a maximum speed, νₘₐₓ, wherein νₘₐₓ is higher-layer configured, set by a rule, or reported as part of DCI. Also, both the network and UE may be assumed to have estimates of both the carrier frequency, F_{c}, as well as the speed-of-light constant value, c. Since the values of both α and |cos Ø_{l,f}| cannot exceed 1, the product αcos Ø_{l,f} is confined within the range −1≤αcos Ø_{l,f}|. Also, the impact of the Doppler term in the channel estimate is correlated with the UE speed, and hence relatively smaller absolute values of αcos Ø_{l,f} have larger impact.

Under this setup, the layer l codebook may take on the form:

$${W}_{{q}_{1} , {q}_{2} , {n}_{1} , {n}_{2} , {n}_{3} , {p}_{l}^{( 1 )} , {p}_{l}^{( 2 )} , {i}_{2 , 5 , l} , t , δ}^{l} = \frac{1}{\sqrt{{N}_{1} {N}_{2} {γ}_{t , l}}} [ \text{} \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} {ψ}_{δ , l , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{t , l}^{( f )} {p}_{l , i , + L , f}^{( 2 )} {φ}_{l , i + L , f} {ψ}_{δ , l , f}\end{matrix} ] , l = 1 , 2 , … , v ,$$

$$and$$

$${γ}_{t , l , δ} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {φ}_{l , i , f} {ψ}_{δ , l , f} \vert}^{2} .$$

Examples of the mappings from i₁ to q₁, q₂, n₁, n₂, n_{3,1}, n_{3,2}, n_{3,3}, n_{3,4}, and from i₂ to i_{2,5,1}, i_{2,5,2}, i_{2,5,3}, i_{2,5,4}, p₁⁽¹⁾, p₂⁽¹⁾, p₃⁽¹⁾ and p₄⁽¹⁾, p₁⁽²⁾, p₂⁽²⁾, p₃⁽²⁾ and p₄⁽²⁾ and quantity ϕ_{l,i,f}may be predetermined, including the ranges of the constituent indices of i₁ and i₂, and δ represents a time-dependent index.

In a first embodiment of the fifth set of embodiments, the product term α, cos Ø_{l,f} is reported in the form of two parameters β_{l,f} and d_{l,f}, wherein the bitwidth of β_{l,f} is one bit, which represents the sign of the product term α. cos Ø_{l,f}, i.e., sign(α. cos Ø_{l,f}), with a value corresponding to either {−1,1}. The second parameter, d_{l,f}, represents the absolute value of the product term α.cos Ø_{l,f}, i.e., |α.cos Ø_{l,f}|. Assuming that the codebook of the parameter d_{l,f} comprises N_{d} values, the bitwidth of reporting d_{l,f} would be [log₂ N_{d}]. The quantized values of the parameter d_{l,f} would comprise values within the range [0,1].

In a second embodiment of the fifth set of embodiments, the product term α.cos Ø_{l,f} is reported in the form a parameter d_{l,f}. Assuming that the codebook of the parameter d_{l,f} comprises N_{d} values, the bitwidth of reporting d_{l,f} would be [log₂ N_{d}]. The quantized values of the parameter d_{l,f} would comprise values within the range [−1,1].

In a third embodiment of the fifth set of embodiments, the value N_{d} is higher-layer configured. In one example, N_{d} is a power-of-two value, e.g., is in the form 2ⁿ for a non-negative integer value n, e.g., n=4 for N_{d}=16.

In a fourth embodiment of the fifth set of embodiments, the value d_{l,f} is reported by the UE as part of the CSI feedback report, wherein the bitwidth of d_{l,f} is [log₂N_{d}].

In a fifth embodiment of the fifth set of embodiments, at least one of the parameter values d_{l,f} and β_{l,f}(e.g., if applicable), are common for all ν layers, e.g., d_{1,f}=d_{2,f}= . . . =d_{ν,f}, and β_{1,f}=β_{2,f}= . . . =β_{ν,f}.

In a sixth embodiment of the fifth set of embodiments, at least one of the parameter values d_{l,f} and β_{l,f}(e.g., if applicable), are common for all transformed frequency domain indices, e.g., d_{l,1}=d_{l,2}= . . . =d_{l,M}, and β_{l,1}=β_{l,2}= . . . =β_{l,M}.

In a seventh embodiment of the fifth set of embodiments, the codebook follows a Type-I codebook approach in which a beam is selected with a co-phasing value reported for another beam.

In an eighth embodiment of the fifth set of embodiments, the parameter value(s) β_{l,f} (e.g., if applicable), are reported in a first of two parts of a CSI report.

In a ninth embodiment of the fifth set of embodiments, the codebook of the parameter d_{l,f} is quantized based on a logarithmic scale. In a first example, the codebook values are in the form

$$\{ \frac{{log}_{2} 1}{{log}_{2} {N}_{d}} , \frac{{log}_{2} 2}{{log}_{2} {N}_{d}} , … , \frac{{log}_{2} {N}_{d}}{{log}_{2} {N}_{d}} \} ,$$

assuming the parameter d_{l,f} is designed as described in the first embodiment of the fifth set of embodiments. In a second example, the codebook values are in the form

$$\{ \frac{- {log}_{2} {N}_{d}}{{log}_{2} {N}_{d}} , \frac{- {log}_{2} ( {N}_{d} - 2 )}{{log}_{2} {N}_{d}} , … , \frac{- {log}_{2} 2}{{log}_{2} {N}_{d}} , \frac{{log}_{2} 2}{{log}_{2} {N}_{d}} , \frac{{log}_{2} 4}{{log}_{2} {N}_{d}} , … , \frac{{log}_{2} {N}_{d}}{{log}_{2} {N}_{d}} \} ,$$

assuming the parameter d_{l,f} is designed as described in the second embodiment of the fifth set of embodiments.

Table 4 illustrates a comparison between different embodiments.

TABLE 4
Comparison Between Embodiments

| Approach 0 | Approach 1 | Approach 2 | Approach 3 |
|---|---|---|---|
| Reported values | Reported values | Reported values | Reported values |
| correspond to more | correspond to | correspond to phase | correspond to the |
| accurate Doppler- | Doppler-related phase | values that capture the | product of a |
| related phase | values | UE (paths) directions | normalized speed and |
| values | | | the cosine of the UE |
| | | | (paths) directions |
| Codebook of | Codebook of values | Codebook of values | Two Codebooks of |
| values is a set of | includes uniform | includes unform | values, one |
| indices of columns | phases | phases | representing a sign of |
| of a 2D DFT | | | a value and another |
| matrix representing | | | representing a scalar |
| the Delay/Doppler | | | attenuation value |
| domain | | | (logarithmic) |
| | | | OR |
| | | | Codebook of values |
| | | | include a range of |
| | | | signed values, e.g., [−1, 1] |
| | | | (logarithmic) |
| Does not require | Does not require | Requires implicit | Does not require |
| any knowledge of | implicit knowledge of | knowledge of UE | implicit knowledge of |
| environment. | UE speed | speed | UE speed, but assumes |
| | | | a maximum speed |
| | | | value |
| Similar resolution | Similar resolution for | Similar resolution for | Higher resolution for |
| for all speeds | all speeds | all speeds | high speeds |
| Provides coarse | Provides coarse | Provides fine | Provides coarse |
| information of the | information of the UE | information of the UE | information of the UE |
| UE direction | direction | direction | direction |
| NOTE: Finer UE | | | |
| direction | | | |
| information may | | | |
| be acquired at the | | | |
| expense of | | | |
| increased CSI-RS | | | |
| burst signaling | | | |
| overhead | | | |

In a sixth set of embodiments, there may be different embodiments that discuss a content and configuration of a CSI report. Combinations of one or more embodiments is not precluded.

In a first embodiment of the sixth set of embodiments, a CSI codebook includes reporting one or more parameters that indicate the evolution of the direction of the UE with respect to the gNB (e.g., a parameter that depends on one or more of the phase values Ø_{l,f}(δ) with respect to Ø_{l,f}(δ−δ₀), where δ₀>0). In a first example, a phase value is reported for each layer and each path, l,f, respectively. In a second example, a phase value is reported for each layer, l. In a third example, a phase value is reported for each path, f.

In a second embodiment of the sixth set of embodiments, a CSI codebook includes reporting of one or more parameters that indicate the evolution of the direction of the UE with respect to the gNB (e.g., a parameter that depends on one or more of the channel gain, i.e., amplitude of one or more channel parameters at time δ, with respect to a prior time δ−δ₀, wherein δ₀>0). In a first example, a differential amplitude value is reported for each layer and each path, l,f, respectively. In a second example, a differential amplitude value is reported for each layer, l. In a third example, a differential amplitude value is reported for each path,f.

In a third embodiment of the sixth set of embodiments, the CSI report corresponding to the proposed codebook is configured via CSI reporting configuration with one or more of the following quantities: ‘CRI’, ‘RI’, ‘PMI’, ‘CQI’, layer index ‘LI’, synchronization signal/physical broadcast channel (“SS/PBCH”) block resource index ‘SSBRI’, ‘L1-SINR’, ‘L1-RSRP’. One or more additional quantities, e.g., ‘DI’ for Doppler shift indication, may also be configured.

In a fourth embodiment of the sixth set of embodiments, a CSI feedback report includes one or more of an indicator of a set of beam indices, an indicator of a set of transformed frequency basis indices, indicators of indices of selected coefficients whose coefficient amplitude values are non-zero (or more generally not fixed), e.g., a coefficients' bitmap, indicators of the amplitude values of the selected coefficients, and indicators of the phase values of the selected coefficients.

In a fifth embodiment of the sixth set of embodiments, a CSI feedback report includes indicators of differential coefficient values (e.g., differential amplitude values and differential phase values with respect to the amplitude values indicated in a prior CSI feedback report).

In a sixth embodiment of the sixth set of embodiments, the CSI feedback report includes location information of the UE. In one example a CSI feedback report corresponding to one codebook includes a differential location information with respect to the location of the UE at the instant of the last CSI feedback report corresponding to a prior codebook transmission.

In a seventh embodiment of the sixth set of embodiments, the CSI feedback report includes correlation information between one or more of the channel coefficients' amplitude values, Doppler related information values, and/or frequency-domain-based phase values.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during atransmission occasion) and a source reference signal (e.g., synchronization signal block (“SSB”), CSI-RS, and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

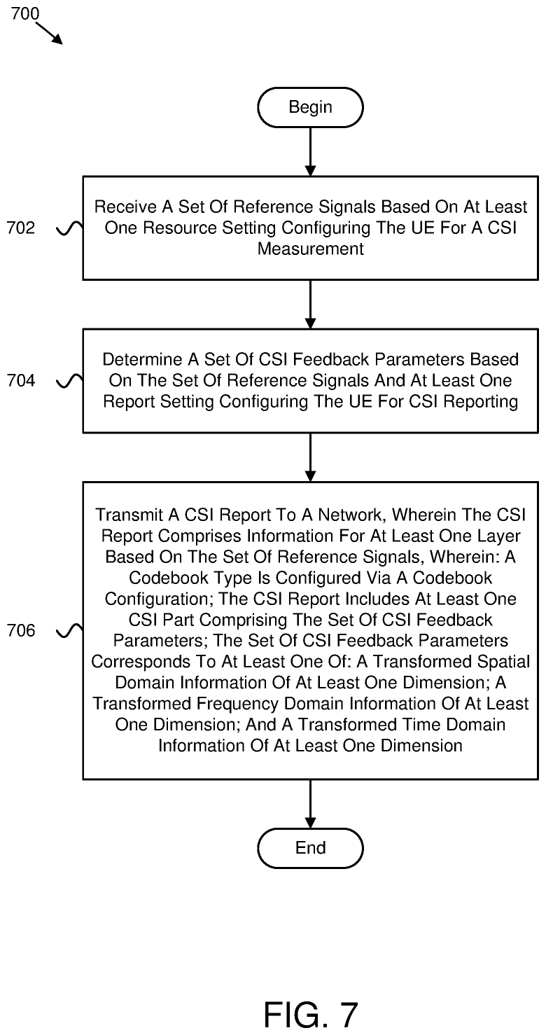

FIG. 7 is a flow chart diagram illustrating one embodiment of a method 700 for transmitting a channel state information report. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702 a set of reference signals based on at least one resource setting configuring the UE for a CSI measurement. In some embodiments, the method 700 includes determining 704 a set of CSI feedback parameters based on the set of reference signals and at least one report setting configuring the UE for CSI reporting. In certain embodiments, the method 700 includes transmitting 706 a CSI report to a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension.

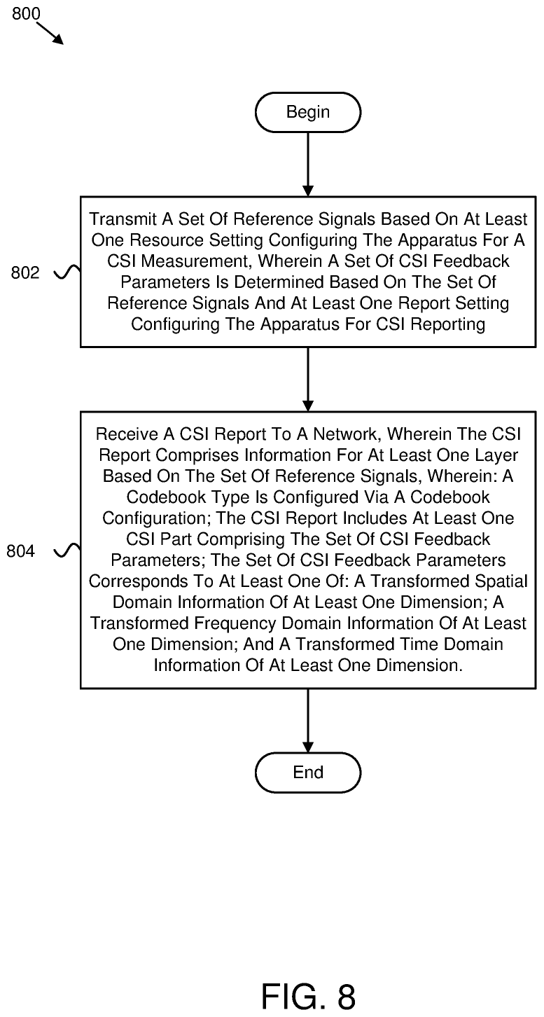

FIG. 8 is a flow chart diagram illustrating another embodiment of a method 800 for transmitting a channel state information report. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes transmitting 802 a set of reference signals based on at least one resource setting configuring the apparatus for a CSI measurement. A set of CSI feedback parameters is determined based on the set of reference signals and at least one report setting configuring the apparatus for CSI reporting. In some embodiments, the method 800 includes receiving 804 a CSI report at a network. The CSI report includes information for at least one layer based on the set of reference signals. A codebook type is configured via a codebook configuration. The CSI report includes at least one CSI part including the set of CSI feedback parameters. The set of CSI feedback parameters corresponds to at least one of: a transformed spatial domain information of at least one dimension; a transformed frequency domain information of at least one dimension; and a transformed time domain information of at least one dimension.

In one embodiment, an apparatus comprises: a receiver to receive a set of reference signals based on at least one resource setting configuring the apparatus for a CSI measurement; a processor to determine a set of CSI feedback parameters based on the set of reference signals and at least one report setting configuring the apparatus for CSI reporting; and a transmitter to transmit a CSI report to a network, wherein the CSI report comprises information for at least one layer based on the set of reference signals, wherein: a codebook type is configured via a codebook configuration; the CSI report includes at least one CSI part comprising the set of CSI feedback parameters; the set of CSI feedback parameters corresponds to at least one of: a transformed spatial domain information of at least one dimension; a transformed frequency domain information of at least one dimension; and a transformed time domain information of at least one dimension.

In certain embodiments, the codebook type comprises a Type-IH codebook.

In some embodiments, the transformed time domain information is reported in a form of an indication of at least one column of a matrix based on a transformation matrix of at least one dimension.

In various embodiments, the transformation matrix of at least one dimension is a DFT matrix of at least one dimension.

In one embodiment, a number of dimensions of the at least one dimension is two.

In certain embodiments, a first dimension of two dimensions of the two-dimensional transformation matrix corresponds to the transformed time domain, and a second dimension of the two dimensions of the two-dimensional transformation matrix corresponds to one of the transformed frequency domain and the transformed spatial domain.

In some embodiments, a subset of dimensions of the at least one dimension of the transformation matrix is oversampled with an oversampling factor of an integer value that is greater than or equal to one.

In various embodiments, the indication of the at least one column of the matrix based on the transformation matrix corresponding to the transformed time domain information is drawn from a codebook of combinatorial values, wherein each value of the codebook of combinatorial values corresponds to a distinct combination of columns of the at least one column of the matrix.

In one embodiment, a number of columns of the distinct combination of columns corresponding to the codebook of the combinatorial values is configured via a higher-layer signaling from the network.

In certain embodiments, the transformed time domain information is common for a subset of layers of the at least one layer of the CSI report.

In some embodiments, the subset of the layers corresponds to all layers of the at least one layer of the CSI report.

In various embodiments, a number of indices of the transformed time domain information is based on a number of received reference signals at the apparatus.

In one embodiment, a bitmap corresponding to each layer of the at least one layer is reported that identifies non-zero coefficients for each layer corresponding to at least one of the transformed spatial domain, the transformed frequency domain, and the transformed time domain.

In one embodiment, a method of a UE, the method comprises: receiving a set of reference signals based on at least one resource setting configuring the UE for a CSI measurement; determining a set of CSI feedback parameters based on the set of reference signals and at least one report setting configuring the UE for CSI reporting; and transmitting a CSI report to a network, wherein the CSI report comprises information for at least one layer based on the set of reference signals, wherein: a codebook type is configured via a codebook configuration; the CSI report includes at least one CSI part comprising the set of CSI feedback parameters; the set of CSI feedback parameters corresponds to at least one of: a transformed spatial domain information of at least one dimension; a transformed frequency domain information of at least one dimension; and a transformed time domain information of at least one dimension.

In one embodiment, an apparatus comprises: a transmitter to transmit a set of reference signals based on at least one resource setting configuring the apparatus for a CSI measurement, wherein a set of CSI feedback parameters is determined based on the set of reference signals and at least one report setting configuring the apparatus for CSI reporting; and a receiver to receive a CSI report at a network, wherein the CSI report comprises information for at least one layer based on the set of reference signals, wherein: a codebook type is configured via a codebook configuration; the CSI report includes at least one CSI part comprising the set of CSI feedback parameters; the set of CSI feedback parameters corresponds to at least one of: a transformed spatial domain information of at least one dimension; a transformed frequency domain information of at least one dimension; and a transformed time domain information of at least one dimension.

In one embodiment, a method at a network device, the method comprises: transmitting a set of reference signals based on at least one resource setting configuring the apparatus for a CSI measurement, wherein a set of CSI feedback parameters is determined based on the set of reference signals and at least one report setting configuring the apparatus for CSI reporting; and receiving a CSI report at a network, wherein the CSI report comprises information for at least one layer based on the set of reference signals, wherein: a codebook type is configured via a codebook configuration; the CSI report includes at least one CSI part comprising the set of CSI feedback parameters; the set of CSI feedback parameters corresponds to at least one of: a transformed spatial domain information of at least one dimension; a transformed frequency domain information of at least one dimension; and a transformed time domain information of at least one dimension.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a set of reference signals based on at least one resource setting configuring the UE for a channel state information (CSI) measurement;
determine a set of CSI feedback parameters based on the set of reference signals and at least one report setting configuring the UE for CSI reporting; and
transmit a CSI report to a network, wherein the CSI report comprises information for at least one layer based on the set of reference signals, wherein:
a codebook type is configured via a codebook configuration;
the CSI report includes at least one CSI part comprising the set of CSI feedback parameters;
the set of CSI feedback parameters corresponds to at least one of:
a transformed spatial domain information of at least one dimension;
a transformed frequency domain information of at least one dimension; and
a transformed time domain information of at least one dimension.

2. The UE of claim 1, wherein the codebook type comprises a Type-II codebook.

3. The UE of claim 1, wherein the transformed time domain information is reported in a form of an indication of at least one column of a matrix based on a transformation matrix of at least one dimension.

4. The UE of claim 3, wherein the transformation matrix of at least one dimension is a discrete Fourier transformation (DFT) matrix of at least one dimension.

5. The UE of claim 4, wherein a number of dimensions of the at least one dimension is two.

6. The UE of claim 5, wherein a first dimension of two dimensions of the two-dimensional transformation matrix corresponds to the transformed time domain, and a second dimension of the two dimensions of the two-dimensional transformation matrix corresponds to one of the transformed frequency domain and the transformed spatial domain.

7. The UE of claim 3, wherein a subset of dimensions of the at least one dimension of the transformation matrix is oversampled with an oversampling factor of an integer value that is greater than or equal to one.

8. The UE of claim 3, wherein the indication of the at least one column of the matrix based on the transformation matrix corresponding to the transformed time domain information is drawn from a codebook of combinatorial values, wherein each value of the codebook of combinatorial values corresponds to a distinct combination of columns of the at least one column of the matrix.

9. The UE of claim 8, wherein a number of columns of the distinct combination of columns corresponding to the codebook of the combinatorial values is configured via a higher-layer signaling from the network.

10. The UE of claim 1, wherein the transformed time domain information is common for a subset of layers of the at least one layer of the CSI report.

11. The UE of claim 10, wherein the subset of the layers corresponds to all layers of the at least one layer of the CSI report.

12. The UE of claim 1, wherein a number of indices of the transformed time domain information is based on a number of received reference signals at the UE.

13. The UE of claim 1, wherein a bitmap corresponding to each layer of the at least one layer is reported that identifies non-zero coefficients for each layer corresponding to at least one of the transformed spatial domain, the transformed frequency domain, and the transformed time domain.

14. A method performed by a user equipment (UE), the method comprising:
receiving a set of reference signals based on at least one resource setting configuring the UE for a channel state information (CSI) measurement;
determining a set of CSI feedback parameters based on the set of reference signals and at least one report setting configuring the UE for CSI reporting; and
transmitting a CSI report to a network, wherein the CSI report comprises information for at least one layer based on the set of reference signals, wherein:
a codebook type is configured via a codebook configuration;
the CSI report includes at least one CSI part comprising the set of CSI feedback parameters;
the set of CSI feedback parameters corresponds to at least one of:
a transformed spatial domain information of at least one dimension;
a transformed frequency domain information of at least one dimension; and
a transformed time domain information of at least one dimension.

15. A base station, comprising:
at least one memory; and
at least one processor coupled with the at least one memory and configured to cause the base station to:
transmit a set of reference signals based on at least one resource setting configuring the base station for a channel state information (CSI) measurement, wherein a set of CSI feedback parameters is determined based on the set of reference signals and at least one report setting configuring the base station for CSI reporting; and
receive a CSI report at a network, wherein the CSI report comprises information for at least one layer based on the set of reference signals, wherein:
a codebook type is configured via a codebook configuration;
the CSI report includes at least one CSI part comprising the set of CSI feedback parameters;
the set of CSI feedback parameters corresponds to at least one of:
a transformed spatial domain information of at least one dimension;
a transformed frequency domain information of at least one dimension; and
a transformed time domain information of at least one dimension.

16. A processor for wireless communication, comprising:
at least one controller coupled with at least one memory and configured to cause the processor to:
receive a set of reference signals based on at least one resource setting configuring the processor for a channel state information (CSI) measurement;
determine a set of CSI feedback parameters based on the set of reference signals and at least one report setting configuring the processor for CSI reporting; and
transmit a CSI report to a network, wherein the CSI report comprises information for at least one layer based on the set of reference signals, wherein:
a codebook type is configured via a codebook configuration;
the CSI report includes at least one CSI part comprising the set of CSI feedback parameters;
the set of CSI feedback parameters corresponds to at least one of:
a transformed spatial domain information of at least one dimension;
a transformed frequency domain information of at least one dimension; and
a transformed time domain information of at least one dimension.

17. The processor of claim 16, wherein the codebook type comprises a Type-II codebook.

18. The processor of claim 16, wherein the transformed time domain information is reported in a form of an indication of at least one column of a matrix based on a transformation matrix of at least one dimension.

19. The processor of claim 18, wherein the transformation matrix of at least one dimension is a discrete Fourier transformation (DFT) matrix of at least one dimension.

20. The processor of claim 19, wherein a number of dimensions of the at least one dimension is two.
